(19) United States
(12) Patent Application Publication
(10) Pub. No.: US 2009/0242352 A1
(43) Pub. Date: Oct. 1, 2009

(54) Rotation stop system

(75) Inventors: Robert Altonji, Quakertown, PA (US); David VanDuzer, Topton, PA (US)

Correspondence Address: DESIGN IP, P.C., 5100 W. TILGHMAN STREET, SUITE 205, ALLENTOWN, PA, 18104, US

(73) Assignee: Innovative Office Products, Inc., Easton, PA (US)

(21) Appl. No.: 12/079,412

(22) Filed: Mar. 25, 2008

(51) Int. Cl. F16D 71/00

(52) U.S. Cl. 192/139

(57) ABSTRACT

A rotation stop system is disclosed, which limits the rotation of a user device mounted to a mounting member. The user device may be connected to an end cap secured to the mounting member. The rotation stop system includes a rotation stop device operable to engage the mounting member and the end cap. The rotation stop device includes a rotation stop collar and at least one rotation stop ring having at least one stop member. The end cap includes a stop engaging member, which is configured to interoperate with the stop members of the rotation stop rings, in order to prevent further rotation of the user device beyond the stop members.

### BACKGROUND OF THE INVENTION

The present invention relates to a device for limiting rotation. More particularly, the present invention relates to a device for limiting the rotation of a user device attached to a mounting apparatus.

Frequently, a user device, such as a computer monitor, flat panel display, or keyboard, is secured to another object, such as a desk, wall, or cubical divider, via a mounting apparatus, such as one of those disclosed in U.S. Pat. No. 7,096,560 (hereinafter “the '560 patent”), entitled “Method of Making a Configurable Mount,” the entire disclosure of which is fully incorporated by reference herein. Additionally, such a user device is often further supported by an extension arm, which connects the user device at one end of the arm to the mounting apparatus at the other end of the arm. One such extension arm is shown and described in U.S. Pat. No. 6,478,274 (hereinafter “the '274 patent”), entitled “Arm Apparatus for Mounting Electronic Devices,” the entire disclosure of which is fully incorporated by reference herein. Another such extension arm is shown and described in pending U.S. application Ser. No. 11/544,076 (hereinafter “the '076 application”), filed Oct. 6, 2006, and entitled “Extension Arm with Moving Clevis,” the entire disclosure of which is fully incorporated by reference herein. As described in the '560 patent, the extension arm may be secured to the mounting apparatus by inserting a cylindrical shaft of the arm into a receptacle in a shaft holder. Such a cylindrical shaft may be, for example, the end cap shaft described in the '274 patent.

In certain mounting apparatuses, once the user device is attached to the mounting apparatus, the user device may be permitted to rotate about the axis of end cap shaft. In such apparatuses, however, there may be a need to limit the degree to which the user device is permitted to rotate, or there may be a need to prevent rotation entirely. In one example, it may be beneficial to limit the rotation of the user device to prevent the cables connected to the device from becoming tangled.

### SUMMARY OF THE INVENTION

In accordance with an embodiment of the present invention, a rotation stop device for limiting the rotation of a device is provided. The rotation stop device comprises a rotation stop collar, a first rotation stop ring, and a second rotation stop ring. The rotation stop collar has a plurality of first engagement members disposed thereon. The first rotation stop ring has opposing first and second surfaces. A plurality of second engagement members are disposed on the first surface, and a plurality of third engagement members are disposed on the second surface. The first surface of the first rotation stop ring is arranged whereby the first and second engagement members are engageable with each other. The second rotation stop ring has a plurality of fourth engagement members disposed thereon. The second surface of the first rotation stop ring is arranged whereby the third and fourth engagement members are engageable with each other. The first rotation stop ring has a first stop member disposed thereon, and the second rotation stop ring has a second stop member disposed thereon. The first and second rotation stop rings are rotatable relative to each other about a common axis upon disengagement of the engagement members. By disengaging the engaging members, the first and second stop members may be arranged in different radial positions about the common axis.

In accordance with another embodiment of the present invention, a rotation stop device for limiting the rotation of a device is provided. The rotation stop device comprises a rotation stop collar, a first rotation stop ring, and a second rotation stop ring. The rotation stop collar has a plurality of first engagement members disposed thereon. The first rotation stop ring has opposing first and second surfaces. A plurality of second engagement members are disposed on the first surface, and a plurality of third engagement members are disposed on the second surface. The first surface of the first rotation stop ring is arranged whereby the first and second engagement members are engageable with each other. The second rotation stop ring has a plurality of fourth engagement members disposed thereon. The second surface of the first rotation stop ring is arranged whereby the third and fourth engagement members are engageable with each other. The first and second rotation stop rings are rotatable relative to each other about a common axis upon disengagement of the engagement members. By disengaging the engaging members, the first and second rotation stop rings may be arranged in different radial orientations about the common axis.

In accordance with another embodiment of the present invention, a rotation stop device for limiting the rotation of a device is provided. The rotation stop device comprises a rotation stop collar, a first rotation stop ring, and a second rotation stop ring. The rotation stop collar includes a first means for engagement. The first rotation stop ring includes a second means for engagement and a third means for engagement. The first and second means for engagement are engageable with each other. The second rotation stop ring includes a fourth means for engagement. The third and fourth means for engagement are engageable with each other. The first rotation stop ring includes a first means for stopping rotation disposed, and the second rotation stop ring includes a second means for stopping rotation. The first and second rotation stop rings are rotatable relative to each other about a common axis upon disengagement of the means for engagement. By disengaging the means for engagement, the first and second means for stopping rotation may be arranged in different radial positions about the common axis.

In accordance with another embodiment of the present invention, a rotation stop device for limiting the rotation of a device is provided. The rotation stop device comprises a rotation stop collar and a rotation stop ring. The rotation stop collar has a plurality of first engagement. members disposed thereon. The rotation stop ring has an opening therein aligned along an axis. The rotation stop ring includes a first stop member and a second stop member. The second stop member is disposed at a defined rotational angle about the axis from the first stop member. The rotation stop ring has a plurality of second engagement members disposed thereon. The first and second engagement members are engageable with each other. The rotation stop ring and the rotation stop collar are rotatable relative to each other about the axis upon disengagement of the engagement members. By disengaging the engagement members, the rotation stop ring may be arranged in a different radial orientation about the axis.

In accordance with another embodiment of the present invention, a system for limiting the rotation of a device is provided. The system comprises a mounting member and a rotation stop device. The mounting member has a longitudinal axis therealong. The rotation stop device is operable to engage the mounting member. The rotation stop device includes a rotation stop collar, a first rotation stop ring, and a second rotation stop ring. The rotation stop collar is operable to engage the mounting member, and the rotation stop collar has a plurality of first engagement members thereon. The first rotation stop ring has opposing first and second surfaces. A plurality of second engagement members are disposed on the first surface, and a plurality of third engagement members are disposed on the second surface. The first surface of the first rotation stop ring is arranged whereby the first and second engagement members are engageable with each other. The second rotation stop ring has a plurality of fourth engagement members disposed thereon. The second surface of the first rotation stop ring is arranged whereby the third and fourth engagement members are engageable with each other. The first rotation stop ring has a first stop member disposed thereon, and the second rotation stop ring has a second stop member disposed thereon. The first and second rotation stop rings are rotatable relative to each other about a common axis upon disengagement of the engagement members. By disengaging the engaging members, the first and second stop members may be arranged in different radial positions about the common axis.

In accordance with another embodiment of the present invention, a system for limiting the rotation of a device is provided. The system comprises a mounting member, an extension arm for supporting a user device, and a rotation stop device. The mounting member has a longitudinal axis therealong. The extension arm has an end cap which is operable to engage the mounting member. The rotation stop device is operable to engage the mounting member. The rotation stop device includes a rotation stop collar, a first rotation stop ring, and a second rotation stop ring. The rotation stop collar is operable to engage the mounting member, and the rotation stop collar has a plurality of first engagement members thereon. The first rotation stop ring has opposing first and second surfaces. A plurality of second engagement members are disposed on the first surface, and a plurality of third engagement members are disposed on the second surface. The first surface of the first rotation stop ring is arranged whereby the first and second engagement members are engageable with each other. The second rotation stop ring has a plurality of fourth engagement members disposed thereon. The second surface of the first rotation stop ring is arranged whereby the third and fourth engagement members are engageable with each other. The first rotation stop ring has a first stop member disposed thereon, and the second rotation stop ring has a second stop member disposed thereon. The first and second rotation stop rings are rotatable relative to each other about a common axis upon disengagement of the engagement members. By disengaging the engaging members, the first and second stop members may be arranged in different radial positions about the common axis.

In one alternative, the first and third engagement members comprise teeth and the second and fourth engagement members comprise indentations. In another alternative, the first and third engagement members comprise indentations and the second and fourth engagement members comprise teeth. In yet another alternative, at least one rotation stop ring includes a skirt surrounding a plurality of the engagement members.

In another alternative, the rotation stop system includes at least one dog operable to engage the mounting member to prevent relative rotation between the rotation stop device and the mounting member about the longitudinal axis. In one example, the dog is operable to engage a slot in the mounting member. In another example, the dog is disposed on the rotation stop collar. In another alternative, the rotation stop system includes at least one alignment aid. In one example, the alignment aid is a notch. In another example, the alignment aid is aligned with the dog.

In another alternative, the end cap is permitted to rotate about the longitudinal axis of the mounting member while engaged with the mounting member. In one alternative, a stop engaging member is disposed on the end cap. In one example, the first and second stop members are operable to engage the stop engaging member of the end cap to prevent further rotation of the end cap beyond the stop members. In one alternative, the end cap includes a shaft disposed thereon, and the mounting member includes a receptacle which is operable to receive the shaft of the end cap. In one example, the rotation stop device is operable to substantially surround the shaft of the end cap while the shaft is received in the receptacle.

In another alternative, the rotation stop system further includes an adapter which is operable to engage the mounting member; the adapter includes a receptacle which is operable to receive the shaft of the end cap. In one alternative, the adapter is permitted to rotate about the longitudinal axis of the mounting member while engaged with the mounting member. In one alternative, a stop engaging member is disposed on the adapter. In one example, the first and second stop members are operable to engage the stop engaging member of the adapter to prevent further rotation of the adapter beyond the stop members. In one alternative, the adapter includes a shaft disposed thereon, and the mounting member includes a receptacle which is operable to receive the shaft of the adapter. In one example, the rotation stop device is operable to substantially surround the shaft of the adapter while the shaft is received in the receptacle.

### BRIEF DESCRIPTION OF THE DRAWINGS

FIGS. 1a-c illustrate perspective views of a rotation stop system in accordance with aspects of the present invention.

FIGS. 2a-b illustrate views of the assembled rotation stop system of FIGS. 1a-c.

FIGS. 3a-b illustrate top and bottom perspective views of a rotation stop system in accordance with aspects of the present invention.

FIG. 4 illustrates a perspective view of an assembled rotation stop system in accordance with aspects of the present invention.

FIGS. 5a-b illustrate views of an assembled rotation stop system in accordance with aspects of the present invention.

FIG. 6 illustrates a perspective view of an alternative rotation stop system in accordance with aspects of the present invention.

FIGS. 7a-f illustrate views of a rotation stop collar in accordance with aspects of the present invention.

FIGS. 8a-g illustrate views of a first rotation stop ring in accordance with aspects of the present invention.

FIGS. 9a-g illustrate views of a second rotation stop ring in accordance with aspects of the present invention.

FIGS. 10a-e illustrate views of an alternative rotation stop ring in accordance with aspects of the present invention.

FIG. 11 illustrates a perspective view of a rotation stop system in accordance with aspects of the present invention.

### DETAILED DESCRIPTION

In describing the preferred embodiments of the invention illustrated in the appended drawings, in which like reference numerals represent like elements, specific terminology will be used for the sake of clarity. However, the invention is not intended to be limited to the specific terms so selected, and it is to be understood that each specific term includes all technical equivalents that operate in a similar manner to accomplish a similar purpose.

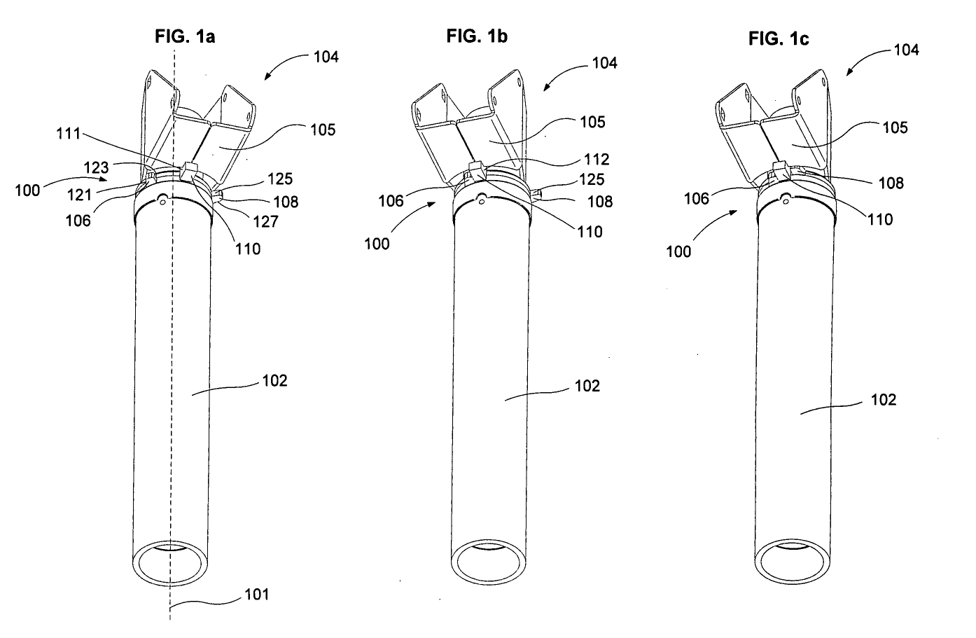

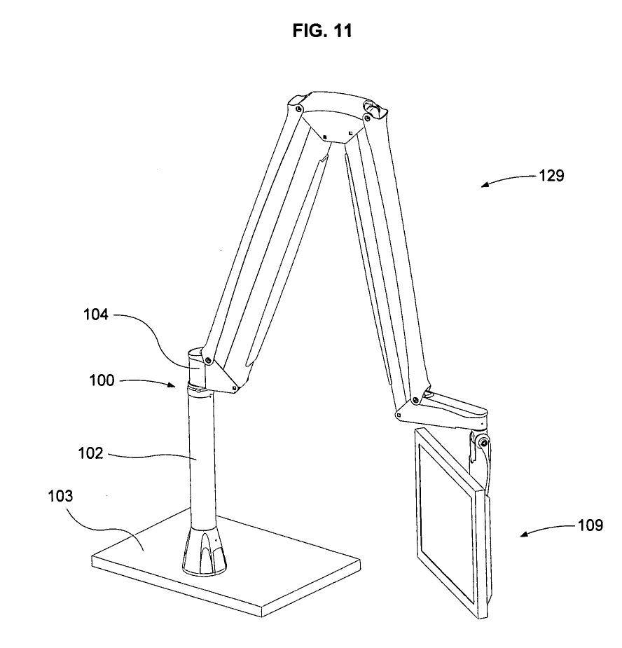

FIGS. 1a-c illustrate a rotation stop system including rotation stop device 100 in accordance with the present invention. FIG. 11 illustrates an overall view of one possible configuration of the rotation stop system in accordance with the present invention. The rotation stop device 100 is connected to a mounting assembly, which includes a mounting member 102. The mounting member 102 may be affixed to various workspace objects, including a piece of furniture such as a desk 103, a wall such as a slat wall, a section of an office cubicle, the floor, etc. The specific configuration of the mounting assembly may be selected depending upon the particular type of workspace object it will connect to. For example, the mounting assembly may include a clamp connected to the mounting member 102 for clamping to the top of a desk 103 or other horizontal surface. Alternatively, the mounting member 102 may be secured to such horizontal surface by threadedly fastening a bolt through a hole in the surface and into a threaded hole in the mounting member 102. Such ways of affixing a mounting member 102 to a workspace are shown and described in pending U.S. application Ser. No. 11/510,393, filed Aug. 25, 2006, and entitled “Locking Device for Computer Equipment Extension Arm,” the entire disclosure of which is fully incorporated by reference herein. In contrast, wall mounting assemblies such as those shown and described in U.S. Pat. No. 7,066,435, the entire disclosure of which is hereby incorporated by reference, can be employed to connect to slat wall or other vertical surfaces.

A user device 109 is secured to the mounting member 102 by an end cap 104. The end cap 104 may be a component of an extension arm 129, such as that described in the '076 application or the '274 patent discussed above, or the end cap 104 may be directly connected to or part of the user device 109, such as a flat panel monitor. As shown in FIGS. 1a-c, the rotation stop device 100 is preferably seated between the mounting member 102 and the end cap 104.

The rotation stop device 100 desirably includes a first stop member 106 and a second stop member 108. The stop members 106 and 108 preferably include tabs that project radially outward from the rotation stop device 100. The first stop member 106 has first and second side surfaces 121, 123, and the second stop member 108 has first and second side surfaces 125, 127.

The end cap 104 preferably includes a stop engaging member 110 rigidly connected thereto. The stop engaging member 110 may be integrally formed on the end cap 104, or it may be rigidly attached thereto by commonly known techniques, such as welding, adhesive bonding, bolting, etc. The stop engaging member 110 may be in the form of a protrusion such as a tab which extends downwardly from a lower surface 105 of the end cap 104, where it is configured to interoperate with the first and second stop members 106, 108.

When the end cap 104 rotates in one direction about longitudinal axis 101 of the mounting member 102, a first side surface 111 of the stop engaging member 110 will preferably come in contact with the second side surface 123 of the first stop member 106, as shown in FIG. 1b, and will prevent the end cap 104 from rotating any further in that direction. Similarly, when the end cap 104 is rotated in the other direction, a second side surface 112 of the stop engaging member 110 will preferably come in contact with the first side surface 125 of the second stop member 108, which will prevent any further rotation in that direction. Alternatively, if the end cap 104 were to be lifted sufficiently off of the mounting member 102 and rotation stop device 100 such that the stop engaging member 110 would avoid contact with either of the stop members 106, 108, the end cap 104 could be rotated past one of the stop members 106, 108 and reseated on the mounting member 102. In this position, the end cap 104 may be rotated between the stop members.106, 108 through the complementary angular positions not previously permitted by the stop members 106, 108. That is, when the end cap 104 is rotated in one direction about longitudinal axis 101, the first side surface 111 of the stop engaging member 110 will preferably come in contact with the second side surface 127 of the second stop member 108, and will prevent the end cap 104 from rotating any further in that direction. When the end cap 104 is rotated in the other direction, the second side surface 112 of the stop engaging member 110 will preferably come in contact with the first side surface 121 of the first stop member 106, which will prevent any further rotation in that direction.

In some embodiments, the first and second stop members 106, 108 may be rotationally displaced with respect to each other, as explained in detail below, such that the rotational angle between the stop members 106, 108, and thus the permissible angle of rotation of the user device 109, may be varied. By varying the rotational positions of the first and second stop members 106, 108, a user may define the extent of the permissible rotational positions of the end cap 104, and thus the user device 109 connected to such end cap 104.

In one scenario, the first and second stop members 106, 108 may be disposed so that the distance between the second side surface 123 of the first stop member 106 and the first side surface 125 of the second stop member 108 substantially corresponds to the thickness of the stop engaging member 110. In such an arrangement, illustrated in FIG. 1c, rotation of the end cap 104 may be completely prevented, and the rotational position of the user device 109 can be fixed.

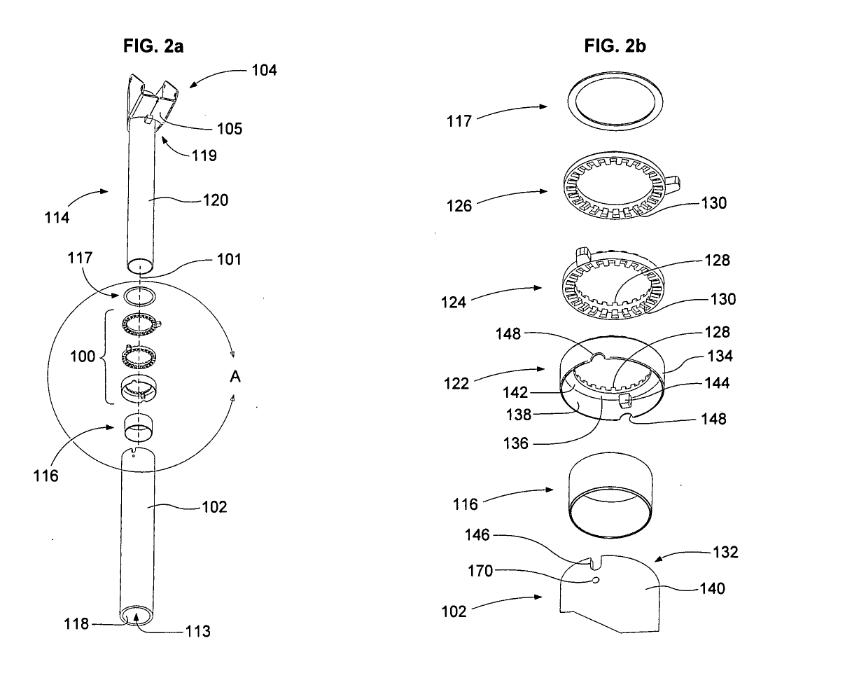

FIG. 2a illustrates an exploded view of the components of the assembly described above. In the embodiment illustrated, the mounting member 102 is a substantially hollow, cylindrical component. The mounting member 102 preferably contains a receptacle 113, which is configured to allow a shaft 114 attached to the end cap 104 to be inserted therein.

In one preferred embodiment, the shaft 114 of the end cap 104 may be hollow, having an interior 115 therein. In such embodiment, the interior 115 of the shaft 114 of the end cap 104 is preferably configured to receive cables, such as power and data cables from the user device 109, therethrough. For example, power and data cables from the user device 109 may run along the top of the extension arm 129 and enter the top 107 of the end cap 104, from which they may run through the interior 115 before exiting from the mounting member 102. Preferably, arranging the cables in such a configuration may beneficially hide the cables from the user's view. Additionally, running the cables through the end cap 104 and the mounting member 102 will preferably prevent the cables from becoming twisted around the mounting member 102 during rotation of the user device 109.

By inserting the shaft 114 of the end cap 104 into the receptacle 113 of the mounting member 102, the user device 109 may be secured to the mounting assembly, while preferably being free to rotate around the longitudinal axis 101 of the end cap shaft 114 and receptacle 113. In order make the rotation of the end cap shaft 114 and the user device 109 easier, a bushing 116 may be placed in the receptacle 113 of the mounting member 102 between inner surface 118 of the receptacle 113 and the outer surface 120 of the shaft 114.

To further aid in positioning of the end cap 104 and thus the rotation of the user device 109, a thrust washer 117 may be placed between the bottom 119 of the end cap 104 and the rotation stop device 100. Since the mounting member 102 and the rotation stop device 100 attached thereto remain rotationally fixed while the end cap 104 with its shaft 114 are permitted to rotate, the bushing 116 and thrust washer 117 are operable to provide smooth, low friction surfaces that allow the moving components to move easily relative to the fixed components.

The rotation stop device 100 is preferably comprised of several components which are shown separated in FIG. 2a. FIG. 2b is a close-up of section A of FIG. 2a. As illustrated in FIG. 2b, the rotation stop device 100 is preferably comprised of a rotation stop collar 122, a lower or first rotation stop ring 124, and an upper or second rotation stop ring 126.

Each of these components is preferably formed from a single piece of material, such as, for example, a polymer or a metal. Each component may be, for example, molded (in the case of a polymer) or cast (in the case of a metal). The collar 122 and the stop rings 124 and 126 are formed to have a first set of engagement members such as teeth 128 that interlock with a second set of engagement members such as indentations 130 in the other components, as discussed in further detail below.

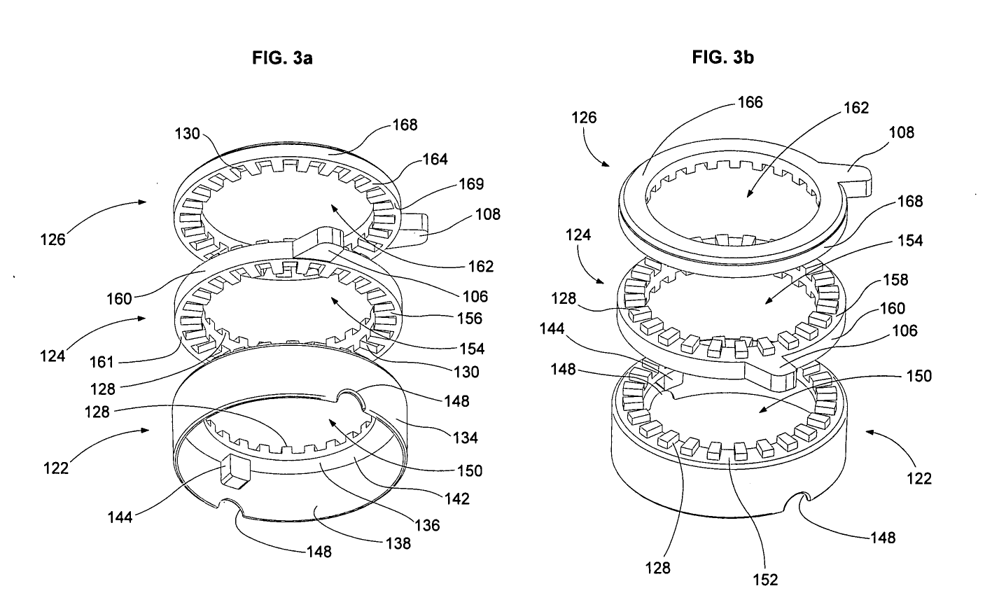

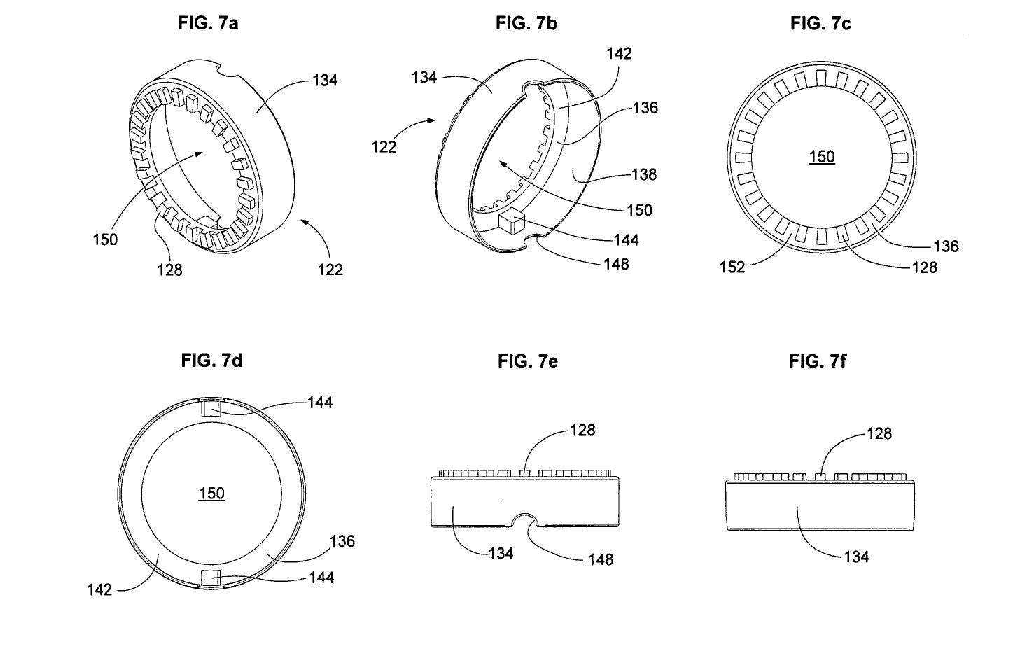

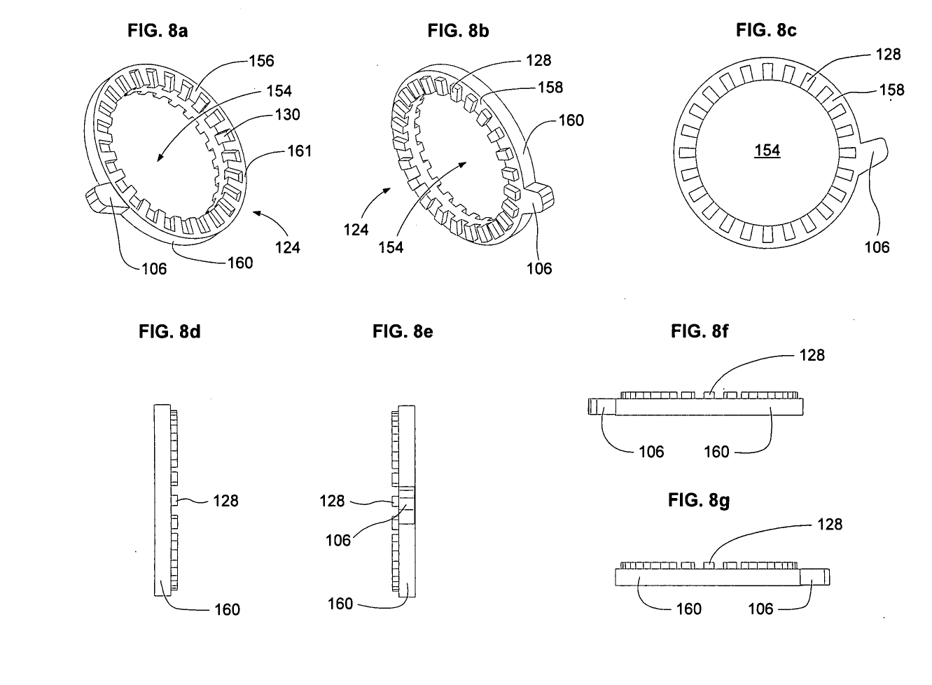

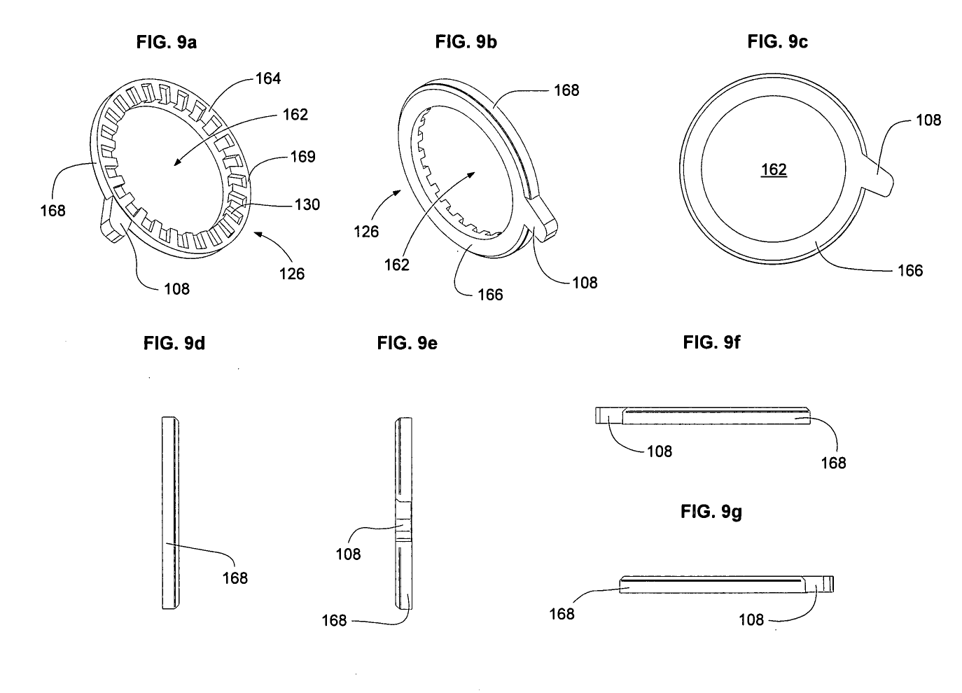

FIGS. 3a-b illustrate top and bottom perspective views of the components of the rotation stop device 100 in accordance with one embodiment of the present invention. Additionally, FIGS. 7a-f illustrate various views of the rotation stop collar 122 in accordance with one embodiment of the present invention. FIGS. 8a-g illustrate various views of the first rotation stop ring 124, which is illustrated as a lower rotation stop ring 124 in the illustrated embodiments of the present invention. FIGS. 9a-g illustrate various views of the second rotation stop ring 126, which is illustrated as an upper rotation stop ring 126 in the illustrated embodiments of the present invention.

As shown in the figures, the rotation stop collar 122 is preferably in the general shape of a cylindrical cup which is configured to engage the top 132 of the mounting member 102. Specifically, the collar 122 may have a first portion 134 and a second portion 136.

The first portion 134 may be shaped like a cylinder having an inner surface 138 dimensioned to complement the outer surface 140 of the top 132 of the mounting member 102. The second portion 136 may be shaped like a planar circular ring having a lower surface 142 configured to rest on the top surface (not shown) of the top 132 of the mounting member 102. Thus, the inner surface 138 and the lower surface 142 are preferably configured to engage the top 132 of the mounting member 102 in such a way that the collar 122 may be securely and concentrically fixed to the mounting member 102 when it is seated on the top 132 thereof.

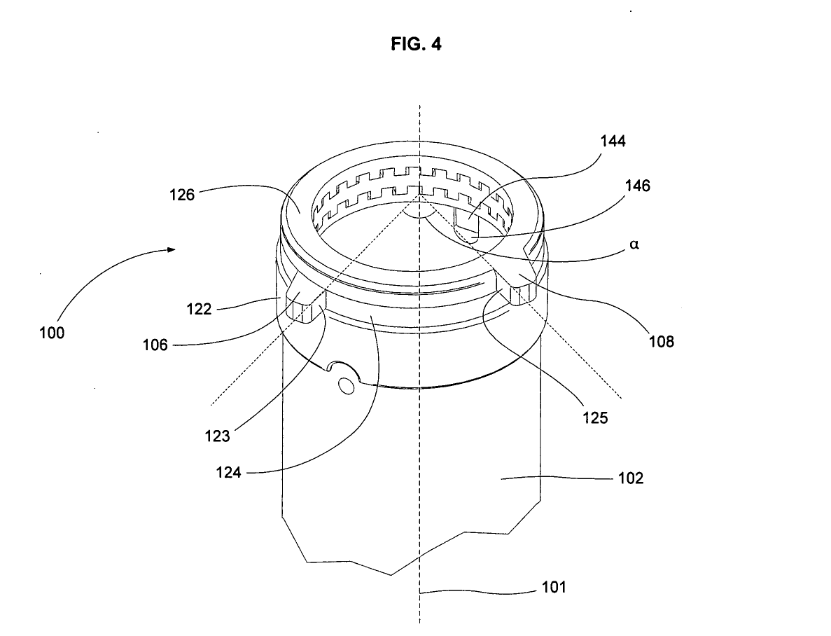

The rotation stop collar 122 also preferably includes at least one retention member such as dog 144. The dog 144 is preferably in the form of a tab which projects from the inner surface 138 and the lower surface 142 of the collar 122. The dog 144 is preferably dimensioned to engage at least one slot 146 in the mounting member 102 when the collar 122 is engaged with the mounting member 102 (see FIG. 2b). When the rotation stop device 100 is seated on the mounting member 102, as is shown in FIG. 4, the dog 144 fits into the slot 146 so that the rotation stop device 100 is prevented from rotating in relation to the mounting member 102. The rotation stop collar 122 may include any number of dogs 144, configured to engage any number of slots 146 in the mounting member 102. The dogs 144 and slots 146 may be disposed at any angular position around the axis 101 of the mounting member 102. In a preferred embodiment, the rotation stop collar 122 may include two dogs 144 disposed opposite each other, such as illustrated in FIG. 7d.

In order to help the user properly align the rotation stop collar 122 with the mounting member 102, the collar may include an alignment aid such as a notch 148. The notch 148 is preferably disposed on the rotation stop collar 122 in the same angular position as the dog 144, although this is not required. In this configuration, when the user is securing the rotation stop collar 122 to the mounting member 102, the user may align the notch 148 with the slot 146 on the mounting member 102 to ensure that the dog 144 will engage the slot 146. In alternative embodiments (not shown), the alignment aid may be a marking on the collar 122 which the user can align with the slot 146.

A top perspective view of the rotation stop collar 122 can be seen in FIG. 3b. The second portion 136 of the collar 122 includes an opening 150, which is dimensioned so that the shaft 114 of the end cap 104 may fit therethrough when the shaft 114 is inserted into the receptacle 113 of the mounting member 102. The second portion 136 preferably also has a substantially planar upper surface 152, having a plurality of teeth 128 disposed thereon surrounding the opening 150. In the illustrated embodiment, the teeth 128 are shaped in the form of projections that extend away from the upper surface 152 of the collar 122. The teeth 128 are configured to engage indentations 130 in the lower rotation stop ring 124 (see FIG. 3a).

The lower rotation stop ring 124 is preferably a substantially ring shaped component having a central opening 154, a lower or first surface 156, an upper or second surface 158, and a first stop member 106. The opening 154 of the lower rotation stop ring 124, like the opening 150 of the rotation stop collar 122, is preferably dimensioned so that the shaft 114 of the end cap 104 may fit therethrough.

The lower surface 156 of the lower rotation stop ring 124 is preferably configured to engage the upper surface 152 of the rotation stop collar 122. Indentations 130, which are dimensioned to complement the shape of the teeth 128 of the rotation stop collar 122, are formed in the lower surface 156 of the lower rotation stop ring 124. When the lower rotation stop ring 124 is seated on the rotation stop collar 122, the teeth 128 of the collar 122 interlock with the indentations 130 of the lower rotation stop ring 124. Once properly seated, the lower rotation stop ring 124 is rotationally fixed with respect to the rotation stop collar 122.

In one preferred embodiment, the indentations 130 of the lower rotation stop ring 124 do not extend to the outer surface 160 of the ring 124, thereby forming a cylindrical skirt 161 along the perimeter of the lower surface 156 of the lower rotation stop ring 124. The teeth 128 of the rotation stop collar 122 are preferably similarly shaped. Thus, when the teeth 128 of the rotation stop collar 122 and the indentations 130 of the lower rotation stop ring 124 are fully engaged, the skirt 161 surrounds the teeth 128 and the indentations 130 so that the zigzag line of the engaged surfaces is beneficially hidden from view.

The first stop member 106 is preferably integrally formed with the lower rotation stop ring 124, and the first stop member 106 preferably projects radially outward from the outer surface 160 of the lower rotation stop ring 124. In order to set the angular position of the first stop member 106 with respect to the mounting member 102, the lower rotation stop ring 124 may be oriented to a desired rotational position before seating it on the rotation stop collar 122.

Once the lower rotation stop ring 124 is properly seated with the teeth 128 engaging the indentations 130, the first stop member 106 defines the furthest permissible angular position of the end cap 104, and thus the user device 109, in one direction about the axis 101 of the mounting member 102. In order to change the angular position of the first stop member 106 with respect to the mounting member 102, the lower rotation stop ring 124 may be lifted up from the rotation stop collar 122 until the teeth 128 become disengaged from the indentations 130, at which point the lower rotation stop ring 124 may be reoriented and reseated on the rotation stop collar 122.

The upper surface 158 of the lower rotation stop ring 124 preferably has a plurality of teeth 128 disposed thereon surrounding the opening 154, similar to the teeth 128 of the rotation stop collar 122. The teeth 128 are configured to engage indentations 130 in the upper rotation stop ring 126.

The upper rotation stop ring 126 is preferably a substantially ring shaped component having a central opening 162, a lower surface 164, an upper surface 166, and a second stop member 108. The opening 162 of the upper rotation stop ring 126, like the opening 150 of the rotation stop collar 122 and the opening 154 of the lower rotation stop ring 124, is preferably dimensioned so that the shaft 114 of the end cap 104 may fit. therethrough.

The lower surface 164 of the upper rotation stop ring 126 is preferably configured to engage the upper surface 158 of the lower rotation stop ring 124. Indentations 130, which are dimensioned to complement the shape of the teeth 128 of the lower rotation stop ring 124, are formed in the lower surface 164 of the upper rotation stop ring 126. When the upper rotation stop ring 126 is seated on the lower rotation stop ring 124, the teeth 128 of the lower rotation stop ring 124 interlock with the indentations 130 of the upper rotation stop ring 126. Once properly seated, the upper rotation stop ring 126 is rotationally fixed with respect to the lower rotation stop ring 124, and is therefore rotationally fixed with respect to the mounting member 102.

In one preferred embodiment, the indentations 130 of the upper rotation stop ring 126 do not extend to the outer surface 168 of the ring 126, thereby forming a cylindrical skirt 169 along the perimeter of the lower surface 164 of the upper rotation stop ring 126. The teeth 128 of the lower rotation stop ring 124 are preferably similarly shaped. Thus, when the teeth 128 of the lower rotation stop ring 124 and the indentations 130 of the upper rotation stop ring 126 are fully engaged, the skirt 169 surrounds the teeth 128 and the indentations 130 so that the zigzag line of the engaged surfaces is beneficially hidden from view.

The second stop member 108 is preferably integrally formed with the upper rotation stop ring 126, and the second stop member 108 preferably projects radially outward from the outer surface 168 of the upper rotation stop ring 126. In order to set the angular position of the second stop member 108 with respect to the mounting member 102, the upper rotation stop ring 126 may be oriented to a desired position before seating it on the lower rotation stop ring 124.

Once the upper rotation stop ring 126 is properly seated with the teeth 128 engaging the indentations 130, the second stop member 108 defines the furthest permissible angular position of the end cap 104, and thus the user device 109, in one direction about the axis 101 of the mounting member 102. The angular position of the second stop member 108 may be changed in a similar manner to that used to change the angular position of the first stop member 106. Namely, upper rotation stop ring 126 may be lifted up from the lower rotation stop ring 124 until the teeth 128 become disengaged from the indentations 130, at which point the upper rotation stop ring 126 may be reoriented and reseated on the lower rotation stop ring 124. Thus, when the lower rotation stop ring 124 is seated on the rotation stop collar 122, and the upper rotation stop ring 126 is seated on the lower rotation stop ring 124, the permissible angular displacement of the user device 109 may be defined between the first stop member 106 and the second stop member 108, as described above.

The upper surface 166 of the upper rotation stop ring 126 is preferably substantially planar. The upper surface 166 is preferably configured to engage the bottom 119 of the end cap 104, such as by allowing the bottom 119 of the end cap 104 to sit upon the upper surface 166, while allowing the end cap 104 to rotate relative to the upper rotation stop ring 126. Alternatively, the upper surface 166 of the upper rotation stop ring 126 may be configured to engage thrust washer 117, which may be seated on the upper surface 166 and disposed between the end cap 104 and the upper rotation stop ring 126, as described above.

FIG. 4 illustrates the components of the rotation stop device 100 interlocked and seated on the top 140 of the mounting member 102, as described above. The teeth 128 are shown interlocked with the indentations 130, thus fixing the angular displacement between the stop members 106, 108. Further, the dog 144 of the rotation stop collar 122 is shown engaged with the slot 146 of the mounting member 102, thus preventing rotation of the rotation stop device 100 with respect to the mounting member 102.

The angle formed between the second side 123 of the first stop member 106 and the first side 125 of the second stop member 108 about axis 101 of the mounting member 102 is angle a. The angle a may preferably be adjusted from 0° to any desired angle, such as 90°, 180°, up to approximately 359° (where the stop members 106, 108 are disposed in overlapping angular positions). This latter orientation of the stop members (i.e., in overlapping angular positions) may be useful, for example, in a situation where the user desires to allow a substantially full range of motion of the user device 109, while preventing the device 109 from fully rotating more than once around the mounting member, which could cause the cables from the user device 109 to become tangled.

In order to adjust the angle a, either or both of the rotation stop rings 124, 126 may be disengaged from the rotation stop collar 122 and/or from each other, so that the teeth 128 are no longer interlocked with the indentations 130. Once disengaged, either or both of the rotation stop rings may be rotated and reseated on the rotation stop collar 122, as shown in FIG. 4, with the teeth 128 interlocked with the indentations 130. Once reseated, a different angle a is preferably formed between the second side 123 of the first stop member 106 and the first side 125 of the second stop member 108.

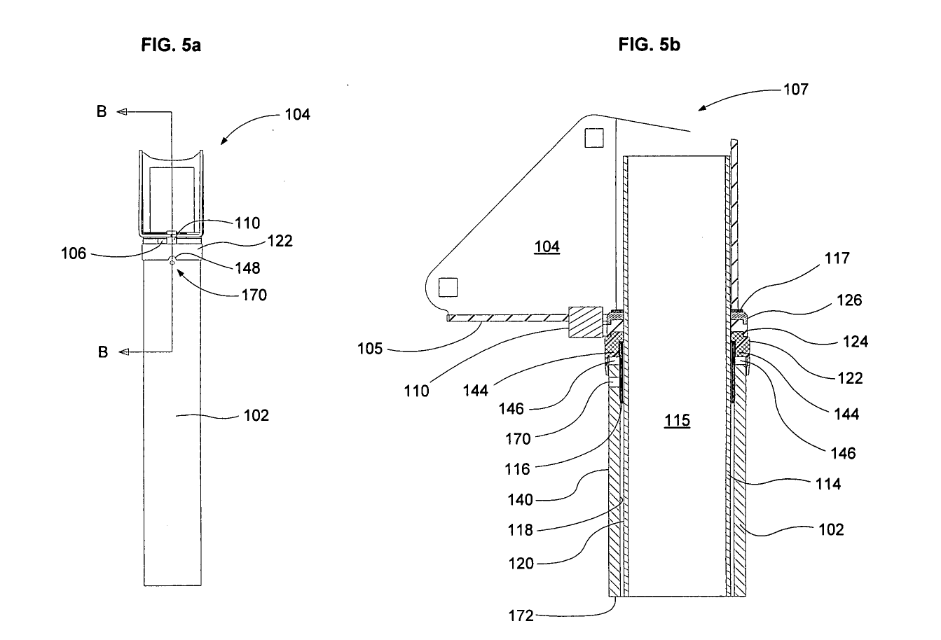

FIG. 5a illustrates a front view of the mounting member 102, the rotation stop device 100, and the end cap 104, all assembled together in a preferred configuration of those components in use. FIG. 5b depicts a cross sectional view taken along line B-B of FIG. 5a. The preferred relationships between the previously described components are clearly illustrated by FIG. 5b.

Additionally, FIG. 5b illustrates a hole 170 going through a wall 172 of the mounting member 102 from the outer surface 140 to the inner surface 118. The hole 170 is preferably threaded and is configured to accept a set screw (not shown). When tightened, the set screw may forcibly engage the bushing 116 and compress the bushing 116 against the outer surface 120 of the end cap shaft 114 in order to produce friction between the end cap 104 and the mounting member 102 and, thus, provide a means of adjusting the feel of moving the end cap 104 as well as preventing the free rotation of the end cap 104.

It is to be noted that the engagement members, such as teeth 128 and indentations 130, of the present invention may be of any shape. In an alternative embodiment (not shown), the teeth 128 of the rotation stop collar 122 and the indentations 130 of the lower rotation stop ring 124 may have one configuration while the teeth 128 of the lower rotation stop ring 124 and the indentations 130 of the upper rotation stop ring 126 may have a different configuration. In such an embodiment, the user may find it easier to properly configure and engage the components, based on the observed shapes of the engagement members.

Additionally, while no specific number of teeth 128 and indentations 130 is required by the present invention, it is to be noted that a larger number of teeth 128 and indentations 130 formed in the rotation stop device 100 may be beneficial. Specifically, a larger number of teeth 128 and indentations 130 may allow for a greater number of defined angular positions of the stop members 106, 108, which, therefore, may allow the user more flexibility and precision in the use of the rotation stop device 100 of the present invention.

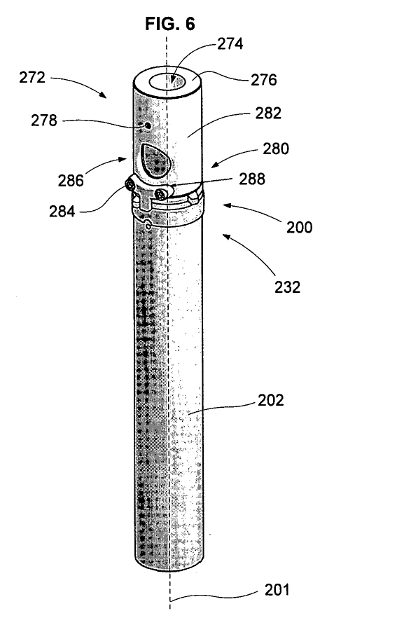

An alternative embodiment of the present invention is illustrated in FIG. 6. In FIG. 6, a rotation stop device 200 substantially as described above is shown disposed on the top 232 of a mounting member 202. An adapter 272 is shown seated on top of the rotation stop device 200. The adapter 272 is preferably a substantially cylindrical shaped member having a receptacle 274 disposed in the top 276 thereof. The receptacle 274 is configured to receive the shaft of an end cap (not shown) in substantially the same manner that the receptacle 113 of the mounting member 102 of the embodiment illustrated in FIG. 2a is configured to receive the shaft 114 of the end cap 104.

The adapter 272 of the present embodiment also preferably contains a shaft (not shown), like the shaft 114 in FIG. 2a, which extends through openings in the rotation stop device 200 and into a receptacle in the mounting member 202. The shaft of the adapter 272 preferably allows the adapter 272 to be secured to the mounting member 202, while allowing the adapter 272 to rotate around the longitudinal axis 201 of the mounting member 202. In this manner, a user device connected to the end cap (not shown), which is in turn connected to the adapter 272 as described above, may be permitted to rotate about the axis 201 of the mounting member 202.

The adapter 272 preferably also includes a hole 278. The rotational position of the end cap and the user device may be fixed in relation to the adapter 272 by tightening a set screw (not shown) disposed within the hole 278. Tightening the set screw will preferably cause the screw to engage the shaft of the end cap (or a bushing surrounding the shaft) and, thereby, lock the angular position of the shaft within the receptacle 274.

In one alternative, the adapter 272 may include an opening 286 in the outer surface 282 thereof. The opening 286 is preferably configured to receive cables, such as power and data cables from the user device, therethrough. When the end cap shaft is fully received in the receptacle 274, the opening 286 is preferably disposed below the bottom of the shaft, such that the shaft does not interfere with the cables passing through the opening 286. In one preferred embodiment, power and data cables from the user device may run along the bottom of the extension arm and enter the opening 286 of the adapter 272. Preferably the adapter shaft is hollow, and the cables may run from the opening 286, through the interior of the adapter shaft, and exit from the mounting member 202. By locating the opening 286 on the adapter 272, which is preferably rotationally fixed with respect to the end cap and the user device, twisting of the cables around the mounting member 202 may be prevented. Additionally, running the cables through the adapter 272 and the mounting member 202 may beneficially hide the cables from the user's view.

In a further alternative, the opening 286 need not be included in the adapter 272, and the cables may run from the user device and through the end cap, as described above with respect to the embodiment illustrated in FIG. 2a. Specifically, the cables from the user device may run along the top of the extension arm and enter the top of the end cap, from which they may run through the interior of the end cap shaft before passing through the adapter 272 and the mounting member 202.

Adapters 272 in accordance with the illustrated embodiment may be created with differently sized receptacles 274. In this manner, users having end caps with shafts that are not configured to fit within the receptacle 113 of the mounting member 102 illustrated in FIG. 2a may nonetheless mount their user device to the mounting member by securing their end cap to the adapter 272 as described above.

The adapter 272 preferably includes a stop engaging member 288. The stop engaging member 288 is preferably in the form of a tab which extends downwardly and is attached to a lower portion 280 of the adapter 272. The stop engaging member 288 may be removably affixed to the outer surface 282 of the adapter 272 by fasteners 284, as illustrated in FIG. 6.

Alternatively, the stop engaging member 288 may be integrally formed with the adapter 272. The stop engaging member 288 is also preferably configured to interoperate with the first and second stop members 206, 208 of the rotation stop device 200 in substantially the same manner as the stop engaging member 110 of the end cap 104 described above with respect to the embodiment of FIGS. 1a-c. In this manner, the user device, which is connected to the end cap, which is in turn connected to the adapter 272, may be permitted to rotate about the axis 201 of the mounting member 202 within a permissible angle of rotation defined by the stop members 206, 208.

In a further alternative, the adapter 272 may not include a stop engaging member 288. Accordingly, for users desiring to retrofit such an adapter 272 for use with the present invention, a kit including a stop engaging member 288, along with fasteners 284, may be provided with the rotation stop device 200 of the present invention. In this manner, users may attach the stop engaging member 288 to the adapter 272 in a location where it may be in a position to engage the first and second stop members 206, 208 of the rotation stop device 200. In order to accommodate the attachment of a stop engaging member 288, an adapter 272 in accordance with the present embodiment preferably includes holes (not shown) configured to securely receive the fasteners 284.

An adapter 272 including a stop engaging member 288 may be useful to a user who has an end cap that does not include a stop engaging member. Alternatively, for such a user having an end cap without a stop engaging member, the stop engaging member 288 of the above-described kit may be secured directly to the end cap in such a location that it may be in a position to engage the first and second stop members of the rotation stop device.

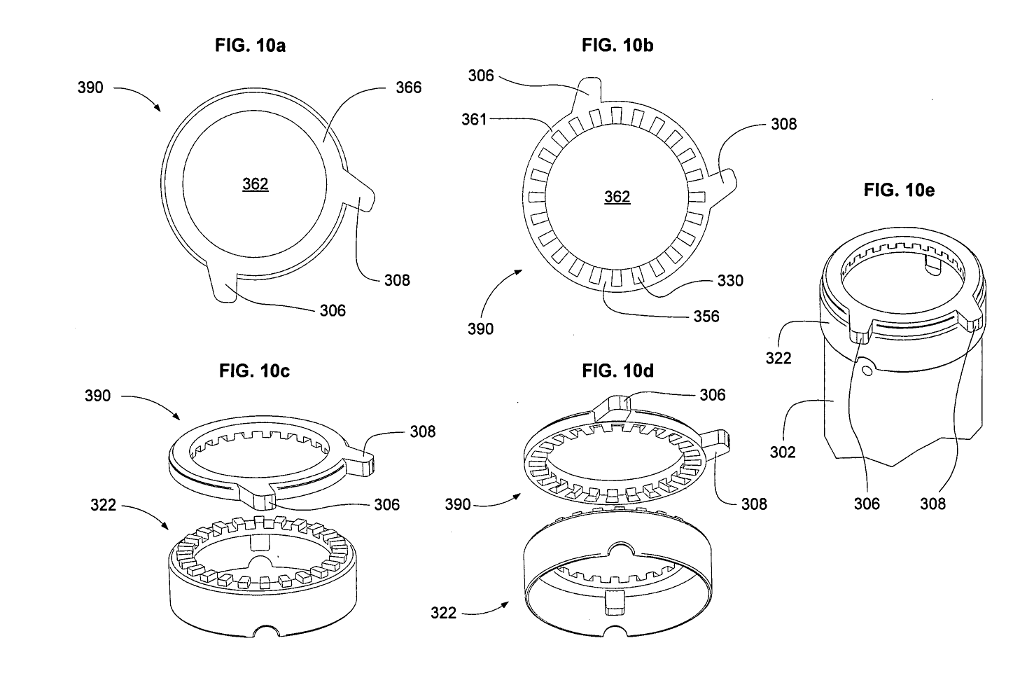

In a further alternative embodiment illustrated in FIGS. 10a-e, the rotation stop device may only require a single rotation stop ring 390, which is preferably configured to engage the rotation stop collar 322. The rotation stop ring 390 in accordance with this embodiment is preferably configured substantially identically to the upper rotation stop ring 126 illustrated in FIGS. 3a-b, except that the rotation stop ring 390 includes two stop members 306, 308 integrally formed therewith at defined angular orientations. The rotation stop device in accordance with the current embodiment may preferably be compatible with multiple interchangeable rotation stop rings 390, each having stop members 306, 308 spaced at particular angular orientations (such as, for example, 45°, 90°, 180°). In this manner, the user may insert and orient a selected rotation stop ring 390 into the rotation stop device in order to define the desired permissible rotational positions of the user device. In order to change the magnitude of the permissible angular rotation of the user device in a rotation stop device in accordance with the current embodiment, the user may remove the previously selected rotation stop ring 390 and replace it with a different rotation stop ring 390 having stop members 306, 308 spaced at different angular orientations than in the previously selected rotation stop ring 390.

Optionally, one of the interchangeable rotation stop rings 390 may only include a single stop member. Such rotation stop ring 390 could be utilized by itself in the rotation stop device by a user who simply wishes to prevent the user device cables from becoming tangled around the mounting member, while still allowing for a maximal range of motion of the user device.

In accordance with all above-described embodiments of the present invention, the configuration of the stop members in the rotation stop device may be set in a variety of ways. For example, the configuration of the rotation stop rings and the rotation stop collar may be set when the entire assembly is assembled. Additionally, the rotation stop device may be adjusted after the entire assembly is assembled. For example, the assembly including the end cap and the rotation stop device may be disassembled so that the rotation stop rings can be disengaged and reengaged in different rotational orientations. In a much easier alternative, however, the end cap or the adapter may be lifted slightly off of the rotation stop device so that the user can manipulate the rotation stop rings.

It is to be noted that although the engagement members of the illustrated embodiments are described as having teeth 128 and indentations 130, the rotation stop system of the present invention is not limited to the use of such components. It is to be understood that any means for substantially rotationally securing the rotation of the rotation stop rings and the rotation stop collar may be employed. Furthermore, although the illustrated embodiments have been described as having teeth 128 disposed on particular surfaces and indentations 130 formed in particular surfaces, it is to be understood that the locations of such components may be reversed, while still falling within the scope of the present invention. That is, for example, though a first surface may be described as having teeth 128 disposed thereon that are configured to engage indentations 130 in a second surface, such first surface may equally include indentations 130 formed therein that are configured to engage teeth 128 on the second surface.

Additionally, it is noted that although the stop members of the illustrated embodiments have been described as projecting radially from the rotation stop device and the stop engaging members have been described as extending downwardly from the end cap or the adapter, it is to be understood that alternative orientations of such components may be employed in accordance with the present invention. For example, the stop engaging members may instead extend upwardly or downwardly in the axial direction where they may be configured to interoperate with a stop engaging member which projects radially outward from the end cap or the adapter.

It is further noted that all features in any of the embodiments are usable with all other embodiments presented herein.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A rotation stop device for limiting rotation of a device about a central axis, the rotation stop device comprising:
a rotation stop collar having a plurality of first engagement members disposed thereon;
a first rotation stop ring having opposing first and second surfaces, said first rotation stop ring having a first stop member disposed thereon, said first rotation stop ring having a plurality of second engagement members disposed on said first surface and a plurality of third engagement members disposed on said second surface, said first surface of said of said first rotation stop ring arranged whereby said first and second engagement members are engageable with each other; and
a second rotation stop ring having a second stop member disposed thereon, said second rotation stop ring having a plurality of fourth engagement members disposed thereon, said second surface of said first rotation stop ring arranged whereby said third and fourth engagement members are engageable with each other;
wherein said first and second rotation stop rings are rotatable relative to each other about said central axis upon disengagement of said engagement members, whereby said first and second stop members are arrangeable in different relative radial positions about said central axis.

2. The rotation stop device of claim 1, wherein said first and third engagement members comprise teeth and said second and fourth engagement members comprise indentations.

3. The rotation stop device of claim 1, wherein said first and third engagement members comprise indentations and said second and fourth engagement members comprise teeth.

4. The rotation stop device of claim 1, wherein at least one of said first and second rotation stop rings further includes a skirt surrounding a plurality of said engagement members.

5. A rotation stop device for limiting rotation of a device about a central axis, the rotation stop device comprising:
a rotation stop collar including a first means for engagement;
a first rotation stop ring including a first means for stopping rotation, said first rotation stop ring including a second means for engagement and a third means for engagement, said first and second means for engagement being engageable with each other; and
a second rotation stop ring including a second means for stopping rotation, said second rotation stop ring including a fourth means for engagement, said third and fourth means for engagement being engageable with each other;
wherein said first and second rotation stop rings are rotatable relative to each other about said central axis upon disengagement of said means for engagement, whereby said first and second means for stopping rotation are arrangeable in different relative radial positions about said central axis.

6. A rotation stop device for limiting rotation of a device about a central axis, the rotation stop device comprising:
a rotation stop collar having a plurality of first engagement members disposed thereon; and
a rotation stop ring having a first stop member and a second stop member disposed thereon, said second stop member being disposed at a defined rotational angle about said axis from said first stop member, said rotation stop ring having a plurality of second engagement members disposed thereon, said first and second engagement members being engageable with each other;
wherein said rotation stop ring and said rotation stop collar are rotatable relative to each other about said central axis upon disengagement of said engagement members, whereby said rotation stop ring may be arranged in a different radial orientation about said central axis.

7. The rotation stop device of claim 6, wherein said first engagement members comprise teeth and said second engagement members comprise indentations.

8. The rotation stop device of claim 6, wherein said first engagement members comprise indentations and said second engagement members comprise teeth.

9. The rotation stop device of claim 6, wherein said rotation stop ring further includes a skirt surrounding a plurality of said engagement members.

10. A system for limiting rotation of a device, comprising:
a mounting member having a longitudinal axis therealong; and
a rotation stop device operable to engage said mounting member, said rotation stop device including:
a rotation stop collar operable to engage said mounting member, said rotation stop collar having a plurality of first engagement members thereon;
a first rotation stop ring having opposing first and second surfaces, said first rotation stop ring having a first stop member disposed thereon, said first rotation stop ring having a plurality of second engagement members disposed on said first surface and a plurality of third engagement members disposed on said second surface, said first surface of said first rotation stop ring arranged whereby said first and second engagement members are engageable with each other; and
a second rotation stop ring having a second stop member disposed thereon, said second rotation stop ring having a plurality of fourth engagement members disposed thereon, said second surface of said first rotation stop ring arranged whereby said third and fourth engagement members are engageable with each other;
wherein said first and second rotation stop rings are rotatable relative to each other about said longitudinal axis upon disengagement of said engagement members, whereby said first and second stop members may be arranged in different relative radial positions about said longitudinal axis.

11. The rotation stop device of claim 10, wherein said first and third engagement members comprise teeth and said second and fourth engagement members comprise indentations.

12. The rotation stop device of claim 10, wherein said first and third engagement members comprise indentations and said second and fourth engagement members comprise teeth.

13. The system of claim 10, further including at least one dog operable to engage said mounting member to prevent relative rotation between said rotation stop device and said mounting member about said longitudinal axis.

14. The system of claim 13, wherein said mounting member includes a slot therein, said dog being operable to engage said slot.

15. The system of claim 13, wherein said dog is disposed on said rotation stop collar.

16. The system of claim 13, further including at least one alignment aid.

17. The system of claim 16, wherein said alignment aid is a notch.

18. The system of claim 16, wherein said alignment aid is aligned with said dog.

19. The system of claim 10, further including an end cap operable to engage said mounting member.

20. The system of claim 19, wherein said end cap is rotatable about said longitudinal axis of said mounting member while engaged with said mounting member.

21. The system of claim 19, further including a stop engaging member disposed on said end cap.

22. The system of claim 21, wherein said first and second stop members are operable to engage said stop engaging member to prevent rotation of said end cap beyond said stop members.

23. The system of claim 19, wherein said end cap includes a shaft disposed thereon, and wherein said mounting member includes a receptacle disposed therein operable to receive said shaft.

24. The system of claim 23, wherein said rotation stop device is operable to substantially surround said shaft of said end cap while said shaft is received in said receptacle.

25. The system of claim 10, further including an adapter operable to engage said mounting member, said adapter including a receptacle therein, said receptacle being operable to receive a shaft of an end cap.

26. The system of claim 25, wherein said adapter is permitted to rotate about said longitudinal axis of said mounting member while engaged with said mounting member.

27. The system of claim 26, further including a stop engaging member disposed on said adapter.

28. The system of claim 27, wherein said first and second stop members are operable to engage said stop engaging member to prevent rotation of said adapter beyond said stop members.

29. The system of claim 25, wherein said adapter includes a shaft disposed thereon, and wherein said mounting member includes a receptacle disposed therein operable to receive said shaft.

30. The system of claim 29, wherein said rotation stop device is operable to substantially surround said shaft of said adapter while said shaft is received in said receptacle.

31. The system of claim 25, wherein said adapter further includes an opening therein adapted to receive at least one user device cable therethrough.

32. A system for limiting the rotation of a user device, comprising:
a mounting member having a longitudinal axis therealong;
an extension arm for supporting a user device, said extension arm having an end cap operable to engage said mounting member; and
a rotation stop device operable to engage said mounting member, said rotation stop device including:
a rotation stop collar operable to engage said mounting member, said rotation stop collar having a plurality of first engagement members thereon;
a first rotation stop ring having opposing first and second surfaces, said first rotation stop ring having a first stop member disposed thereon, said first rotation stop ring having a plurality of second engagement members disposed on said first surface and a plurality of third engagement members disposed on said second surface, said first surface of said first rotation stop ring arranged whereby said first and second engagement members are engageable with each other; and
a second rotation stop ring having a second stop member disposed thereon, said second rotation stop ring having a plurality of fourth engagement members disposed thereon, said second surface of said first rotation stop ring arranged whereby said third and fourth engagement members are engageable with each other;
wherein said first and second rotation stop rings are rotatable relative to each other about said longitudinal axis upon disengagement of said engagement members, whereby said first and second stop members may be arranged in different relative radial positions about said longitudinal axis.

33. The system of claim 32, wherein said end cap is permitted to rotate about said longitudinal axis of said mounting member while engaged with said mounting member.

34. The system of claim 33, further including a stop engaging member disposed on said end cap.

35. The system of claim 34, wherein said first and second stop members are operable to engage said stop engaging member to prevent rotation of said end cap beyond said stop members.

36. The system of claim 32, wherein said end cap includes a shaft disposed thereon, and wherein said mounting member includes a receptacle disposed therein operable to receive said shaft.

37. The system of claim 36, wherein said rotation stop device is operable to substantially surround said shaft of said end cap while said shaft is received in said receptacle.
